(19) United States
(12) Patent Application Publication
(10) Pub. No.: US 2025/0381705 A1
(43) Pub. Date: Dec. 18, 2025

(54) BINDER COMPOSITION AND METHOD FOR MANUFACTURING A WOOD-BASED MATERIAL AND WOOD-BASED MATERIAL

(71) Applicant: SWISS KRONO Tec AG, Luzern (CH)

(72) Inventors: Norbert Kalwa, Horn - Bad Meinberg (DE); Joachim Hasch, Berlin (DE); Andreas Gier, Mandelbachtal (DE); Tomasz Lucjan, Gersau (CH)

(73) Assignee: SWISS KRONO Tec AG, Luzern (CH)

(21) Appl. No.: 18/879,413

(22) PCT Filed: May 30, 2023
(86) PCT No.: PCT/EP2023/064449

§ 371 Date: Dec. 27, 2024

(30) Foreign Application Priority Data
Jun. 27, 2022 (EP) 22181367.8

(51) Int. Cl. B27N 3/00; B01J 31/02; B27N 3/04; C09J 175/04

(52) U.S. Cl. CPC B27N 3/002; B01J 31/0239; B27N 3/04; C09J 175/04

(57) ABSTRACT

The invention relates to a binder composition for manufacturing a wood-based material, a method for manufacturing such a wood-based material and such a wood-based material. In order to provide a binder composition for manufacturing a wood-based material, in which the speed of curing can be specifically controlled and at the same time diffusion of the binder into the wood material to be bound is prevented in the best possible way, thereby ensuring a safe, fast and cost-effective manufacturing process with the lowest possible use of binder, fast and cost-effective manufacturing process with the lowest possible binder consumption without reducing the product quality, it is provided that the binder composition comprises an organic phase having at least one polymer adhesive, an aqueous phase, at least one phase transfer catalyst for accelerating the curing of the polymer adhesive and a hydrophilizing agent comprising or formed from at least one silane compound for increasing the hydrophilicity of the polymer adhesive and/or for reducing the penetration of the polymer adhesive into the material of the wood-based material to be bonded.

### BACKGROUND OF THE INVENTION

The invention relates to a binder composition for manufacturing a wood-based material, in particular a board-shaped wood-based material, such as chipboard or fiberboard, in particular OSB, HDF or MDF boards, as well as plywood and glued laminated timber, a method for manufacturing such a binder composition, a method for manufacturing such a wood-based material and such a wood-based material.

A variety of binder compositions, in particular binders, are used in the manufacturing of wood-based materials. Depending on the application, different binder compositions are favored or are particularly suitable. Binder compositions based on urea/formaldehyde have proven to be particularly suitable for wood-based boards that are later to be used in furniture production or interior design.

For applications where increased humidity or moisture from adjacent components is to be expected, e.g. floor coverings, urea-formaldehyde binders, possibly reinforced with melamine, are usually used, whereby the increased requirements are taken into account by increasing the amount of binder composition.

For wood-based boards that are used in areas with high humidity or in direct contact with water, urea-formaldehyde binders reinforced with melamine resin, phenolic resins or polymeric diphenylmethane diisocyanate (PMDI) have proven to be suitable. Plywood, chipboards and OSB (oriented strand boards) in particular are used for the various applications. Although all binders that are not hydrolyzed by moisture or water can generally be used for the wood-based materials described above, polymeric diphenylmethane diisocyanate (PMDI) has proven to be particularly suitable for OSB.

In the manufacturing of wood-based materials, the fundamental objectives are generally to use the equipment as effectively as possible and to use the raw materials as effectively as possible. These two objectives are often in conflict with each other. For example, in order to achieve the highest possible plant speed, an increased quantity of binder must be used. If, on the other hand, an optimized method of operation with regard to the amount of binding agent is used, the plant speed must be reduced. In general, the heat transport from the heating plates of the press to the middle of the chip material or fiber cake is a limiting factor. Depending on the mode of operation, this conflict of objectives leads to higher fixed costs for the equipment used or to higher material costs. This problem can be reduced somewhat by using hardeners or aggregates that allow heat to be introduced into the chip or fiber cake at an accelerated rate.

However, it should be noted that although hardeners, for example, allow faster curing, they lead to pre-curing of the binders during system downtimes. This is particularly problematic when using polymeric diphenylmethane diisocyanate. This polymer adhesive reacts with many catalysts at room temperature, which can lead to pre-curing. Accordingly, it is advantageous to use a catalyst that makes curing easy to control and causes as little pre-curing as possible.

With an appropriate catalyst, the binder composition cures in a targeted manner only at the desired time, which, however, leads to the disadvantage that the non-cured binder remains in contact with the wood material to be bonded for longer during the process and increasingly penetrates into it. Studies have shown that when applying binder to wood material, e.g. with PMDI, and in particular to strands for OSB made from softwoods, the binder is particularly likely to penetrate or diffuse into the wood. One reason for this is that the hydrophobic PMDI binder in particular is absorbed by the wood surface, which contains more or less fatty acids depending on the season. This means that the binder is only partially available for gluing the strands in the surface, so that a high amount of binder is required to achieve a sufficient bond. This leads to increased manufacturing costs and, in some cases, to less than optimal application of the binder. In addition, there are technological restrictions due to the penetration of the binder into the wood material with regard to the equipment to be used and the possible process control.

### SUMMARY OF THE INVENTION

The invention is therefore based on the object of providing a binder composition for manufacturing a wood-based material, in particular a board-shaped wood-based material, a method for manufacturing such a wood-based material and such a wood-based material in which the speed of curing of the binder can be specifically controlled and at the same time diffusion of the binder into the wood material to be bound is prevented in the best possible way, thereby enabling a safe, fast and cost-effective manufacturing process with the lowest possible use of binder without a reduction in product quality.

According to the invention, the object is solved by a binder composition for manufacturing a wood-based material, by a method for manufacturing a wood-based material and by a wood-based material all as disclosed herein. Advantageous further embodiments of the invention are also disclosed and/or given in the dependent claims.

The binder composition according to the invention for manufacturing a wood-based material, in particular a board-shaped wood-based material, such as chipboard or fiberboard, in particular OSB, HDF or MDF boards, as well as plywood and glued laminated timber, comprises an organic phase having at least one polymer adhesive, an aqueous phase, at least one phase transfer catalyst for accelerating the curing of the polymer adhesive and a hydrophilizing agent comprising or formed from at least one silane compound for increasing the hydrophilicity of the polymer adhesive and/or for reducing the penetration of the polymer adhesive into the material to be bonded, in particular into the chip material to be bonded, of the wood-based material.

The invention further relates to a method for manufacturing a binder composition according to the invention, comprising at least the steps of providing at least one silane compound, preferably at least two different silane compounds, in particular of the general formulae (I) and/or (II), an addition of at least one polyalcoholic compound to the at least one silane compound and preferably an addition of at least one catalyst, in particular an acid, to the mixture of at least one silane compound and at least one polyalcoholic compound. Subsequently, precipitation and/or separation of the reaction mixture of the at least one silane compound and the at least one polyalcoholic compound is carried out and the phase transfer catalyst is added. At the same time or preferably subsequently, an addition of at least one polymer adhesive system to the phase transfer catalyst and/or the separated reaction mixture of the at least one silane compound and the at least one polyalcoholic compound is then finally carried out. In addition, the manufacturing of a binder composition according to the invention can also be carried out exclusively using a silane compound without a polyalcohol as a reaction partner, so that no corresponding catalyst is then required. In this case, only at least one silane compound as hydrophilizing agent, a phase transfer catalyst and at least one polymer adhesive are mixed together.

The invention also relates to a method for manufacturing a wood-based material, in particular a board-shaped wood-based material, such as chipboard or fiberboard, in particular OSB, HDF or MDF boards, as well as plywood and glued laminated timber, wherein first a manufacturing and/or a providing of a chip material and subsequently an addition of a binder composition to the chip material is carried out, wherein the binder composition comprises an organic phase having at least one polymer adhesive and a second aqueous phase immiscible with the organic phase, a phase transfer catalyst for accelerating the curing of the polymer adhesive, as well as a hydrophilizing agent comprising at least one silane compound for increasing the hydrophilicity of the polymer adhesive and/or for reducing the penetration of the polymer adhesive into the chip material of the wood-based material to be bonded. Finally, the wood-based material is formed from the glued chip material, in particular by pressing into a board shaped wood-based material.

The wood-based material according to the invention, in particular manufactured according to the method according to the invention, has at least one chip material and at least one cured binder composition in at least one layer of the wood-based material, in particular a binder composition according to the invention, wherein the binder composition comprises at least one cured polymer adhesive, a phase transfer catalyst for accelerating the curing of the polymer adhesive and a hydrophilizing agent comprising at least one silane compound for increasing the hydrophilicity of the polymer adhesive and/or for reducing the penetration of the polymer adhesive into the chip material of the wood-based material to be bonded.

Finally, the invention relates to the use of a binder composition according to the present invention with a phase transfer catalyst for the manufacture of a wood-based material and preferably in the manufacturing of chipboards or fiberboards, in particular OSB, HDF or MDF boards, as well as plywood and glued laminated timber.

The inventors have recognized that the use of a phase transfer catalyst in combination with a hydrophilizing agent in a binder composition of a wood-based material makes it possible to specifically control the reactivity and thereby both the speed of curing and at the same time to successfully minimize or even essentially prevent the binder from being knocked away or penetrating the wood to a greater extent, so that at the same time a small amount of the binder can be used and a particularly uniform and targeted curing can be achieved.

In addition, the combination of the hydrophilizing agent with the phase transfer catalyst has the advantage that the heat required for setting or curing reaches the binder particularly evenly, since at least the majority of the binder is located between the chip material and not inside the wood, so that a particularly uniform effect of the catalyst can be achieved.

A binder composition is understood to be a composition which is intended for the addition and bonding of wood and, in particular, chip material for a wood-based material, the binder composition preferably being formed in such a way that a wood-based material can be manufactured exclusively from the chip material and the binder composition. In principle, however, it is also possible to add further components, such as additives and fillers, to the wood-based material. The binder composition may already be ready for use and/or be formed from a single component.

Alternatively, however, the binder composition can also be formed from several separately provided components, in particular from two components, which are only brought together and mixed before or during use. In particular, the organic phase can be one component and the aqueous phase the other component, with the phase transfer catalyst and/or the hydrophilizing agent preferably being contained in the aqueous phase. In addition, however, it is also conceivable that the hydrophilizing agent and/or the phase transfer catalyst is provided as a salt or dissolved as a further, in particular third and/or fourth component and/or is only added for use. Both the phase transfer catalyst and the hydrophilizing agent can also be manufactured in-situ. The ready-to-use binder composition consisting of one or more already mixed components is often also referred to as binder or resin and, accordingly, the application of the binder to the chip material is referred to as applying binder.

Furthermore, it is particularly conceivable that the multiple components of the binder composition only come together on the surface of the wood to be bonded, in particular the chip material, whereby preferably a first component, in particular an aqueous phase, the phase transfer catalyst and/or the hydrophilizing agent is first applied to the chip material and/or added to the chip material and then the organic phase with the at least one polymer adhesive, in particular an isocyanate binder, is added.

The wood-based material can in principle be any material, the majority of which, preferably apart from the binder composition, is formed from at least 90% wood, plant fibers and/or a material produced therefrom by bonding several pieces of this material with a binder composition. Preferably, this is at least one chip material. The wood-based material can in principle have any shape, with board-shaped wood-based materials and in particular lignocellulose and/or fiber-containing boards, chipboards and/or coarse particle boards being preferred.

In principle, the chip material can have any plant chips and/or fibers and is preferably formed essentially from plant chips. It is particularly preferred that the chip material is manufactured from wood. Most preferably, the chip material consists of long chips (strands) and/or coarse chips, in particular for manufacturing a coarse particle board, also called oriented strand board (OSB). The wood chips manufactured or provided for manufacturing an oriented strand board can have a length of between 50 and 200 mm, preferably 70 to 180 mm, more preferably 90 to 150 mm; a width of between 5 and 50 mm, preferably 10 to 30 mm, more preferably 15 to 20 mm; and a thickness of between 0.1 and 2 mm, preferably between 0.3 and 1.5 mm, more preferably between 0.4 and 1 mm. For particle boards or chipboards, the chip sizes for the top and/or core layer are preferably in the range of <1 mm to approx. 30 mm.

Although the shaping of the wood-based material can in principle be carried out in any way, it is preferably carried out as a continuous process, in particular by spreading the glued chip material onto a conveyor device, in particular onto a conveyor belt, and/or by pressing the glued chip material into the wood-based material. The forming of the wood-based material and in particular the pressing is preferably carried out under high pressure and/or at a high temperature, preferably of at least 150° C., particularly preferably between 170° C. and 220° C. and very particularly preferably between 180° C. and 220° C.

It is particularly preferred that the glued chip material for manufacturing a coarse chipboard is spread alternately lengthwise and crosswise to the production direction by spreading devices, so that the chip material is arranged crosswise, particularly preferably in at least three layers, especially a lower surface layer, a core layer and an upper surface layer. The spreading direction of the lower and upper surface layer is preferably the same and/or differs from the spreading direction of the core layer.

The manufacturing of the chip material is preferably carried out by peeling debarked round wood, preferably softwood, in the longitudinal direction and/or by rotating knives. It is also preferred that the chip material produced is dried before the binder is added, in particular to reduce the natural moisture of the chip material at high temperatures. Particularly preferably, the moisture of the chip material after drying is below 10% and most preferably below 7% in order to avoid splitting during subsequent pressing and/or to avoid strong vapor formation during pressing.

The addition of the binder composition to the chip material is preferably an application of binder to at least part and preferably all of the chip material as the starting material for the wood-based material. Furthermore, the binder composition is preferably applied to the chip material in a finely distributed manner. Alternatively, it is conceivable that a first component of the binder composition is first applied or the chip material is soaked therein and only then is the second component applied. The amount of the binder composition, in particular in the case of the use of PMDI as binder, is preferably 1 to 10% by weight, particularly preferably 1.5 to 5% by weight, most preferably 2 to 5% by weight and particularly preferably 2 to 3% by weight relative to the total amount of chip material.

In the case of the wood-based material according to the invention, the binder composition is preferably completely cured after manufacturing thereof, in particular preferably an isocyanate binder is reacted with the water of the aqueous phase to form carbamic acids and/or further to form the corresponding amines and/or polyureas. The cured binder composition preferably consists essentially of polyureas, the phase transfer catalyst and/or further components of the organic and/or aqueous phase.

According to the invention, the binder composition has at least one polymer adhesive and preferably at least one isocyanate binder. In principle, the binder composition may have only a single polymer adhesive or a mixture of several polymer adhesives, in particular depending on the desired properties of the wood-based material produced, wherein particularly preferably all polymer adhesives are polyurethane adhesives and/or each have at least one isocyanate binder or are based on at least one diisocyanate. The proportion of all binders in the binder composition is preferably between 60% and 100%, particularly preferably at least 85% and very particularly preferably at least 95%. Preferably, the polymer adhesive and in particular polymeric diphenylmethane diisocyanate is used as a pure binder and/or without any further addition of water in the organic phase. The proportion of water or the proportion of the aqueous phase in the binder composition is preferably between o and 15%, more preferably between 0.01 and 10% and most preferably between 0.5 and 8%.

According to the invention, the binder composition has at least one, preferably exactly one, phase transfer catalyst, although it is also conceivable in principle to use several chemically different phase transfer catalysts at the same time. The phase transfer catalyst according to the invention basically enables the entry of components of the aqueous phase, in particular water itself, into the non-aqueous or organic phase, in particular to the polymer adhesive and/or an isocyanate binder, the water then being particularly preferably the reactant for curing the binder. Accordingly, the phase transfer catalyst preferably transfers water from the aqueous phase to the organic phase, where a reaction with the polymer adhesive and in particular the isocyanate can be carried out and the phase transfer catalyst is subsequently released again.

Thus, the phase transfer catalyst accelerates the reaction of curing of the binder, but is not itself directly involved in the reaction. In particular, the phase transfer catalyst is preferably selected in such a way that it is not involved in activating the isocyanate group of the binder. The phase transfer catalyst leads to a lower necessary reaction temperature and/or to a shortened reaction time and also enables good controllability of the reaction kinetics. There is preferably a linear relationship between the gelling time or the duration of curing and the amount of phase transfer catalyst used.

The hydrophilizing agent is basically a substance or a mixture of substances which influences the hydrophilic properties of the binder and, in particular, increases the hydrophilicity. For this purpose, the hydrophilizing agent preferably has at least one hydrophilic section and at least one hydrophobic section, with the hydrophobic region also preferably interacting directly with the binder composition and/or with the polymer adhesive contained therein.

The hydrophilizing agent can be a pure individual substance or a mixture of substances, whereby the hydrophilizing agent can in particular be a mixture of different substances produced by a reaction. The reaction of at least one silane compound and at least one polyalcohol initially produces a compound or a reaction mixture which is highly hydrophilic on one side of the molecule due to the large number of OH groups in the polyalcohol. On the other hand, due to the specifically modified silane, the molecule produced from the silane compound and the polyalcohol has reactive groups that can react with the polymer adhesive, such as PMDI binder, or also with the OH groups of the wood. These new compounds and the macromolecules created by condensation with the polymer adhesive or the binder are now no longer able to pass through the hydrophobic fatty acid layer of the chip material due to the hydrophilic groups. As a result, the binder composition remains on the surface of the chip material or the fibers and does not diffuse into the wood matrix. Accordingly, the hydrophilizing agent preferably acts by providing the polymer adhesive with a hydrophilic anchor. However, as an alternative to a reaction product, a silane or a silane compound, and in particular a suitably modified silane compound, can also be used as a hydrophilizing agent.

In order to control the reaction of the at least one silane compound with the at least one polyalcohol, a catalyst is preferably added. Particularly suitable catalysts are inorganic and/or organic acids, which are particularly preferably selected from a group comprising phosphoric acid, acetic acid, p-toluene sulfonic acid, hydrochloric acid, formic acid or sulfuric acid. Ammonium salts such as ammonium sulphate, which react as weak acids, are also suitable. However, p-toluene sulfonic acid is particularly preferred.

The use of sodium glycerophosphate has proved to be particularly suitable for precipitating the reaction mixture of at least one silane compound and in particular at least one compound of the formula (I) and/or (II) and at least one polyalcoholic compound. Other precipitating agents that may be considered are alkalis such as NaOH, KOH or ammonium hydroxide solutions. Preferably, the precipitating agent is added to the reaction mixture together with water. In this way, the reaction product is concentrated in the aqueous phase and separated from the hydrolysis products, such as ethanol.

Although in principle at least one phase transfer catalyst of any kind can be used, in an advantageous embodiment of the binder composition the phase transfer catalyst has an onium ion and preferably an ammonium, phosphonium and/or sulfonium ion and is particularly preferably triethylbenzylammonium chloride. In addition, at least one phase transfer catalyst may also be a crown ether, in particular 12-crown-4.

In a preferred embodiment of the binder composition according to the invention, the polymer adhesive is exclusively a polyurethane adhesive based on an isocyanate binder, preferably based on aromatic polyisocyanates, in particular polydiphenylmethane diisocyanate (PMDI), toluene diisocyanate (TDI) and/or diphenylmethane diisocyanate (MDI). A polymeric diphenylmethane diisocyanate is particularly preferred. In particular, the only polymer adhesive is preferably a polyurethane adhesive based on a polymeric diphenylmethane diisocyanate. Generally, the content of polymer adhesive in the binder composition is preferably at least 70% by weight, more preferably at least 80% by weight and most preferably at least 95% by weight.

In an equally preferred embodiment of the binder composition according to the invention, it is also possible to use more than one polymer adhesive. Thus, in particular, several polyaddition adhesives, such as an epoxy resin adhesive, polycyanurate adhesive and/or a polyurethane adhesive, in particular a polyurethane adhesive based on polydiphenylmethane diisocyanate (PMDI), can in principle be used, it being particularly preferred that all polymer adhesives are each based on at least one diisocyanate.

Preferably, the hydrophilizing agent comprises at least one polyalcohol and, in particular, the hydrophilizing agent is formed by a reaction of the at least one silane compound with at least one polyalcohol. The at least one polyalcohol of the hydrophilizing agent is preferably selected from a group comprising tetravalent, pentavalent, hexavalent alditols or a higher-valent alcohol with more than six hydroxy groups as a polyalcoholic compound. The use of n-polyglycols and n-polyvinyl alcohols as polyalcohols is also conceivable in principle. The amount of the polyalcoholic compound in the binder composition is preferably between 5 and 50% by weight, particularly preferably between 10 and 30% by weight and very particularly preferably between 5 and 10% by weight relative to the total amount of the binder composition.

A particularly preferred embodiment of the binder composition according to the invention also provides that at least one alditol is selected from a group comprising as tetravalent alcohols threitol, erythritol, pentaerythritol, as pentavalent alcohols arabitol, adonitol, xylitol and as hexavalent alcohols sorbitol, mannitol, dulcitol, dipentaerythritol. Alditols are also known as reduced sugars. Higher-valent alcohols with more than six hydroxy groups, such as sieve or eight hydroxy groups, can also be used. Suitable polyglycols are, for example, polyethylene or polypropylene glycols. However, the use of sorbitol has proven to be particularly advantageous.

A particularly preferred embodiment of the binder composition according to the invention provides that the at least one silane compound is a compound of the general formula (I)

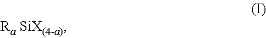

or the general formula (II)

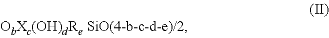

wherein
X is H, OH or a hydrolyzable group selected from the group consisting of halogen, alkoxy, carboxy, amino, monoalkylamino or dialkylamino, aryloxy, acyloxy, alkylcarbonyl,
R is a non-hydrolyzable organic group R selected from the group consisting of substituted and unsubstituted alkyl, substituted and unsubstituted aryl, substituted and unsubstituted alkenyl, substituted and unsubstituted alkynyl, substituted and unsubstituted cycloalkyl, which may be interrupted by-O-or-NH-, and wherein
R may have at least one functional group Q selected from a group comprising an epoxy, hydroxy, ether, amino, monoalkylamino, dialkylamino, substituted and unsubstituted anilino, amide, carboxy, alkynyl, acrylic, acryloxy, methacrylic, methacryloxy, mercapto, cyano, alkoxy, isocyanato, aldehyde, alkylcarbonyl, acid anhydride and/or phosphoric acid group,
R and X can be the same or different from each other, and
a=0, 1, 2, 3, in particular o or 1,
b, c, d=0 or 1, and
e=1, 2, 3.

The silane-containing compounds of the general formula (II) are derived directly as hydrolysis and/or condensation products from the silane compounds of the general formula (I). The hydrolysis and/or condensation of the compounds of the general formula (I) is caused and influenced in particular by the reaction conditions, in particular by acidic reaction conditions, during binder production.

In the silane compounds of the formula (I), the group X is advantageously selected from a group comprising fluorine, chlorine, bromine, iodine, C₁₋₆-alkoxy, in particular methoxy, ethoxy, n-propoxy and butoxy, C₆-C₁₀-aryloxy, in particular phenoxy, C₂-C₇-acyloxy, in particular acetoxy or propionoxy, C₂-C₇-alkylcarbonyl, in particular acetyl, monoalkylamino or dialkylamino with C₁-C₁₂, in particular C₁-C₆. Particularly preferred hydrolyzable groups are C₁-C₄-alkoxy groups, especially methoxy and ethoxy.

Preferably, the silane compound has a non-hydrolyzable organic group R. In the context of the present invention, the term “non-hydrolyzable organic group” is to be understood as an organic group which, in the presence of water, does not lead to the formation of an OH group or NH2 group linked to the Si atom. The non-hydrolyzable group R is preferably selected from a group comprising substituted and unsubstituted C₁-C₃₀-alkyl, in particular C₅-C₂₅-alkyl, substituted and unsubstituted C₂-C₆-alkenyl, substituted and unsubstituted C₂-C₆-alkynyl and substituted and unsubstituted C₆-C₁₀-aryl. Preferably, the non-hydrolyzable group R is selected from the group comprising methyl, ethyl, n-propyl, isopropyl, n-butyl, s-butyl, t-butyl, pentyl, hexyl, cyclohexyl, vinyl, 1-propenyl, 2-propenyl, butenyl, acetylenyl, propargyl, phenyl and naphthyl.

The non-hydrolyzable group R can have at least one functional group Q. In addition, the group R may also be substituted with other groups. In one variant, the at least one functional group Q is selected from a group comprising epoxy, hydroxy, ether, acrylic, acryloxy, methacrylic, methacryloxy-, amino, alkoxy, cyano and/or isocyano groups. In a further variant, the at least one functional group Q contained in the organic non-hydrolyzable group R advantageously comprises an epoxy group, in particular a glycidyl or glycidyloxy group, an alkoxy group, an amino group or an isocyano group.

The functional groups, via which crosslinking with the polymer adhesive and the wood surface is possible, comprise in particular polymerizable and/or polycondensable groups, whereby the polymerization reaction is also to be understood as polyaddition reactions. The functional groups are preferably selected in such a way that organic crosslinking between the polymer adhesive and the wood surface and optionally also between different adhesive systems can be carried out via optionally catalyzed polymerization and/or condensation reactions.

In a particularly preferred embodiment, the silanes used are tetraethoxysilane, methyltriethoxysilane, gamma-isocyanatopropyltriethoxysilane or a glycidyloxypropyl triethoxysilane.

The term “substituted”, in use with “alkyl”, “alkenyl”, “aryl”, etc., denotes the substitution of one or more atoms, usually H atoms, by one or more of the following substituents, preferably by one or two of the following substituents: halogen, hydroxy, protected hydroxy, oxo, protected oxo, C₃-C₇-cycloalkyl, bicyclic alkyl, phenyl, naphthyl, amino, protected amino, monosubstituted amino, protected monosubstituted amino, disubstituted amino, guanidino, protected guanidino, a heterocyclic ring, a substituted heterocyclic ring, imidazolyl, indolyl, pyrrolidinyl, C₁-C₁₂-alkoxy, C₁-C₁₂-acyl, C₁-C₁₂-acyloxy, acryloyloxy, nitro, carboxy, protected carboxy, carbamoyl, cyano, methylsulfonylamino, thiol, C₁-C₁₀-alkylthio and C₁-C₁₀-alkylsulfonyl. The substituted alkyl groups, aryl groups, alkenyl groups, can be substituted once or several times and preferably once or twice, with the same or different substituents.

The term “alkynyl” as used herein denotes a group of the formula R−C=C−, in particular a “C₂-C₆-alkynyl”. Examples of C₂-C₆-alkynyls include: ethynyl, propynyl, 2-butynyl, 2-pentinyl, 3-pentinyl, 2-hexynyl, 3-hexynyl, 4-hexynyl, vinyl, and di- and tri-ynes of straight and branched alkyl chains. The term “aryl” as used herein refers to aromatic hydrocarbons, for example phenyl, benzyl, naphthyl, or anthryl. Substituted aryl groups are aryl groups as defined above substituted with one or more substituents as defined above. The term “cycloalkyl” includes the groups cyclopropyl, cyclobutyl, cyclopentyl, cyclohexyl and cycloheptyl.

In a preferred embodiment, the present binder composition has at least two silane compounds and particularly preferably two different compounds of the general formula (I) and/or (II). A binder composition is preferred in which a first compound corresponds to the formula SiX₄ wherein X is OH or alkoxy, in particular methoxy, ethoxy, n-propoxy or i-propoxy, and a second compound corresponds to the formula RₐSiX₍₄₋ₐ₎ with a=1 or 2, wherein X is OH or alkoxy, in particular methoxy, ethoxy, n-propoxy or i-propoxy, R is methyl, ethyl, n-propyl or n-butyl and Q is a glycidyl or glycidyloxy group, an alkoxy, an amine or an isocyano group. Here, the molar ratio of first and second compound can be 0.1 to 1 mol, preferably 0.1 to 0.5 mol, more preferably 0.1 to 0.4 mol.

Furthermore, it is preferred that the amount of reaction mixture of at least one silane compound, in particular of the formula (I) and/or (II), and the at least one polyalcoholic compound is preferably from 1 to 20% by weight, particularly preferably from 2 to 15% by weight and very particularly preferably from 3 to 10% by weight, based on the amount of polymer adhesive. The content of the silane compound, the hydrophilizing agent and/or the phase transfer catalyst is preferably between 1 to 30% by weight, particularly preferably 5 to 20% by weight and most preferably between 10 to 20% by weight. However, the solvent content from the polymer adhesive used is not initially taken into account in these specifications.

A particularly preferred variant of the present binder composition comprises tetraethyl orthosilicate, glycidyloxypropyl triethoxysilane, sorbitol, triethylbenzyl ammonium chloride as phase transfer catalyst and PMDI binder as polymer adhesive.

An advantageous further development of the method according to the invention for manufacturing a wood-based material provides that the addition of the binder composition to the chip material is carried out in the form of an addition of two separate components of the binder composition, one component being an organic phase having the polymer adhesive and the other component being at least one aqueous phase containing the phase transfer catalyst and/or the hydrophilizing agent. Alternatively, the addition of the phase transfer catalyst and/or the hydrophilizing agent is preferably carried out together with paraffin, with the phase transfer catalyst and/or the hydrophilizing agent being particularly preferably mixed with the paraffin beforehand. The application of the aqueous phase and/or the paraffin with the phase transfer catalyst and/or the hydrophilizing agent to the chip material is carried out particularly preferably via nozzles or atomizers in a mixer or is sprayed onto the chip material in a coil.

In a further preferred embodiment of the method according to the invention for manufacturing a wood-based material, the phase transfer catalyst and/or the hydrophilizing agent is added directly to the chip material to be bonded and/or not first to the organic phase having the polymer adhesive, so that preliminary reactions can be avoided particularly effectively, for example in the event of a plant shutdown.

Although manufacturing a single-layered wood-based material is also conceivable, the wood-based material is preferably structured from at least two different layers and/or from a lower surface layer, a core layer and an upper surface layer, wherein at least one of the layers, preferably the core layer, has a binder composition with a phase transfer catalyst and a hydrophilizing agent and at least one further layer has a binder composition without or with a lower concentration of the phase transfer catalyst and/or the hydrophilizing agent. Preferably, the two surface layers have an identical binder composition and/or an identical amount of binder. Particularly preferably, both surface layers are formed identically to each other. Further preferably, the concentration of the phase transfer catalyst and/or the hydrophilizing agent in the surface layer corresponds to between 25% and 75%, preferably between 40% and 60% and particularly preferably between 45% and 55% of the concentration in the core layer.

The content of binder composition in the wood-based board, in particular an OSB wood-based board, is preferably between 0.5 and 5.0% by weight, particularly preferably 1.5 and 4.0% by weight and very particularly preferably 2.0 and 3.0% by weight based on the total amount of wood fibers or chip material. In a preferred embodiment, the binder composition is sprayed onto the wood chips, onto the chip material or onto the wood fibers.

### DETAILED DESCRIPTION

The invention is explained in more detail below with reference to exemplary embodiments.

### Exemplary Embodiment 1

On a plant for manufacturing OSB with three layers, a core layer and two outer surface layers, the chip material designated as strands for a core layer in the coil was sprayed with a 12.5% solution of Inosil GS 55 as a silane compound and a 20% solution of TEBA (triethylbenzylammonium chloride) as a phase transfer catalyst. The amount of Inosil GS 55 was 0.04 wt % based on wood atro and the amount of TEBA was 1.0 wt % based on wood atro.

Subsequently, the core layer strands were sprayed with 2.0 wt % PMDI (polymeric diphenylmethane diisocyanate) as a polymer adhesive and 1 wt % paraffin. An 18 mm OSB was then manufactured from the middle layer strands and top layer strands, which had been sprayed with 2.9 wt % PMDI and 1.0 wt % paraffin in a coil. The ratio between the top and core layers was equal in terms of quantity.

The OSB plant was operated at a speed of 450 mm/sec and at the usual pressures (200-500 N/cm²) and usual temperatures (210-250° C.). The OSB produced with the parameters described meets all the requirements of the standards applicable to this product.

However, when manufacturing an OSB without Inosil GS 55 and TEBA under otherwise identical conditions and in particular with the same amount of polymer adhesive and at the same speed, splitting occurred, so that the product quality had to be assessed as insufficient. When manufacturing OSBs with either Inosil GS 55 or TEBA in the above-mentioned quantities, OSBs were obtained which, however, had insufficiently high transverse tensile strengths of less than 0.3 N/mm². The moduli of elasticity (longitudinal and transverse) of the boards were also below the standard requirements.

### Exemplary Embodiment 2

On a plant for manufacturing OSB with three layers, a core layer and two outer surface layers, the chip material known as strands was sprayed with a 12.5% solution of Inosil GS 55 and a 20% solution of TEBA (triethylbenzylammonium chloride) for a core layer in the coil. The amount of Inosil GS 55 was 0.04 wt % based on wood atro and TEBA was 1.0 wt % based on wood atro. The strands were further sprayed with 2.0 wt % PMDI and 1 wt % paraffin.

The strands for the surface layer were sprayed in the coil with a 12.5% solution of Inosil GS 55 and a 20% solution of TEBA (triethylbenzylammonium chloride). The amount of Inosil GS 55 was 0.04 wt % based on wood atro and of TEBA 0.5 wt % based on wood atro. The strands were further sprayed with 2.5 wt % PMDI and 1 wt % paraffin.

An 18 mm OSB was then manufactured from the middle layer strands and top layer strands. The ratio between the top and core layers was the same in terms of quantity. The OSB plant was operated at a speed of 470 mm/sec and at the usual pressures (200-500 N/cm²) and usual temperatures (210-250° C.). The OSB produced with the parameters described meets all the requirements of the standards applicable to this product.

When manufacturing an OSB without Inosil GS 55 and without TEBA in the top and core layer under otherwise identical conditions and in particular with the same amount of polymer adhesive and at the same speed, splitting again occurred. When manufacturing OSB with either Inosil GS 55 or with TEBA with the above-mentioned quantities, OSB were obtained, but again with insufficient transverse tensile strengths below 0.3 N/mm². The moduli of elasticity (longitudinal and transverse) of the boards were also again below the standard requirements.

With the binder composition according to the invention, effective system utilization is thus possible, with performance increases of up to approx. 30% being possible. In addition, the amount of polymer adhesive used can be kept low.

1. Binder composition for manufacturing a wood-based material, comprising
an organic phase having at least one polymer adhesive,
an aqueous phase,
a phase transfer catalyst to accelerate curing of the polymer adhesive and
a hydrophilizing agent comprising at least one silane compound for increasing hydrophilicity of the polymer adhesive and/or for reducing penetration of the polymer adhesive into material of the wood-based material to be bonded.

2. Binder composition for manufacturing a wood-based material according to claim 1, wherein the phase transfer catalyst has an onium ion.

3. Binder composition for manufacturing a wood-based material according to claim 1, wherein the phase transfer catalyst is a crown ether.

4. Binder composition for manufacturing a wood-based material according to claim 1, wherein all polymer adhesives of the organic phase are exclusively polyurethane adhesives.

5. Binder composition for manufacturing a wood-based material according to claim 1, wherein the sole polymer adhesive is a polyurethane adhesive based on a polymeric diphenylmethane diisocyanate.

6. Binder composition for manufacturing a wood-based material according to claim 1, wherein the hydrophilizing agent comprises at least one polyalcohol selected from a group containing tetravalent, pentavalent, hexavalent alditols or a higher-valent alcohol having more than six hydroxy groups as a polyalcoholic compound.

7. Binder composition for manufacturing a wood-based material according to claim 6, wherein at least one alditol is selected from a group comprising as tetravalent alcohols threitol, erythritol, pentaerythritol, as pentavalent alcohols arabitol, adonitol, xylitol and as hexavalent alcohols sorbitol, mannitol, dulcitol, dipentaerythritol.

8. Binder composition for manufacturing a wood-based material according to claim 1, wherein the at least one silane compound is a compound of the general formula (I) 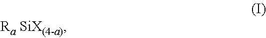
or the general formula (II) 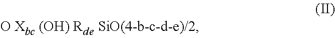
where
X is H, OH or a hydrolyzable group selected from the group consisting of halogen, alkoxy, carboxy, amino, monoalkylamino or dialkylamino, aryloxy, acyloxy, alkylcarbonyl,
R is a non-hydrolyzable organic group R selected from the group consisting of substituted and unsubstituted alkyl, substituted and unsubstituted aryl, substituted and unsubstituted alkenyl, substituted and unsubstituted alkynyl, substituted and unsubstituted cycloalkyl, which may be interrupted by —O—or —NH—, and wherein
R may have at least one functional group Q selected from a group comprising an epoxy, hydroxy, ether, amino, monoalkylamino, dialkylamino, substituted and unsubstituted anilino, amide, carboxy, alkynyl, acrylic, acryloxy, methacrylic, methacryloxy, mercapto, cyano, alkoxy, isocyanato, aldehyde, alkylcarbonyl, acid anhydride and/or phosphoric acid group,—R and X can be the same or different from each other, and
a=0, 1, 2, 3,
b, c, d=0 or 1, and
e=1, 2, 3.

9. Method of manufacturing a binder composition according to claim 1, comprising the steps of:
providing at least one silane compound,
adding at least one polyalcoholic compound,
precipitating and/or separating the reaction mixture of the at least one silane compound and the at least one polyalcoholic compound,
adding the phase transfer catalyst, and
adding at least one polymer adhesive system to the phase transfer catalyst and/or the separated reaction mixture of the at least one silane compound and the at least one polyalcoholic compound.

10. Method of manufacturing a wood-based material, comprising the steps of:
manufacturing and/or providing a chip material,
adding a binder composition to the chip material, wherein the binder composition has an organic phase comprising at least one polymer adhesive and a second aqueous phase immiscible with the organic phase, a phase transfer catalyst for accelerating the curing of the polymer adhesive and a hydrophilizing agent comprising at least one silane compound for increasing the hydrophilicity of the polymer adhesive and/or for reducing the penetration of the polymer adhesive into the chip material of the wood-based material to be bonded, and
forming the wood-based material from the glued chip material, in particular pressing it into a board- shaped wood-based material.

11. Method for manufacturing a wood-based material according to claim 10, wherein the adding of the binder composition to the chip material is carried out in the form of adding two separate components of the binder composition, one component being an organic phase having the polymer adhesive and the other component being at least one aqueous phase containing the phase transfer catalyst and/or the hydrophilizing agent.

12. Method for manufacturing a wood-based material according to claim 10, wherein the phase transfer catalyst and/or the hydrophilizing agent is added directly to the chip material to be bonded and/or is not first added to the organic phase having the polymer adhesive.

13. Method for manufacturing a wood-based material according to claim 10, wherein the wood-based material is structured from at least two different layers and/or from a lower surface layer, a core layer and an upper surface layer, at least one of the layers having a binder composition with a phase transfer catalyst and a hydrophilizing agent and at least one further layer having a binder composition without or with a lower concentration of the phase transfer catalyst and/or the hydrophilizing agent.

14. Method for manufacturing a wood-based material according to claim 13, wherein the two surface layers have an identical binder composition and/or an identical amount of binder and/or the concentration of the phase transfer catalyst and/or the hydrophilizing agent in the surface layer is between 25% and 75% of the concentration in the core layer.

15. A wood-based material having at least one chip material and at least one cured binder composition in at least one layer of the wood-based material, wherein the binder composition has at least one cured polymer adhesive, a phase transfer catalyst for accelerating curing of the polymer adhesive and a hydrophilizing agent comprising at least one silane compound for increasing hydrophilicity of the polymer adhesive and/or for reducing penetration of the polymer adhesive into the chip material of the wood-based material to be bonded.

16. Binder composition for manufacturing a wood-based material according to claim 2, wherein the phase transfer catalyst further comprises an ammonium, phosphonium and/or sulfonium ion.

17. Binder composition for manufacturing a wood-based material according to claim 2, wherein the phase transfer catalyst is triethylbenzylammonium chloride.

18. Binder composition for manufacturing a wood-based material according to claim 3, wherein the crown ether is 12-crown-4.

19. Method for manufacturing a wood-based material according to claim 9, further comprising adding at least one catalyst to the mixture of at least one silane compound and at least one polyalcoholic compound.

20. Method for manufacturing a wood-based material according to claim 13, wherein the core layer has the binder composition with the phase transfer catalyst and the hydrophilizing agent.
